(19) United States
(12) Patent Application Publication
(10) Pub. No.: US 2026/0147315 A1
(43) Pub. Date: May 28, 2026

(54) STRIKING MECHANISM WITH FLEXIBLE TRANSLATION GUIDE

(71) Applicant: Montres Breguet S.A., L'Abbaye (CH)

(72) Inventors: Matthieu CHAPRON, Valleiry (FR); Jérôme MACE, Le Pont (CH); Younes KADMIRI, Montfaucon (FR)

(73) Assignee: Montres Breguet S.A., L'Abbaye (CH)

(21) Appl. No.: 19/381,108

(22) Filed: Nov. 6, 2025

(30) Foreign Application Priority Data
Nov. 28, 2024 (EP) 24216234.5

(51) Int. Cl. G04B 21/06; G04B 23/02

(52) U.S. Cl. CPC G04B 21/06; G04B 23/026

(57) ABSTRACT

A striking mechanism (1) for a horology movement including a vibrating element (11) and a striking device (12) on said vibrating element (11), the striking device (12) including a mobile hammer (13) for striking the vibrating element (11), and a flexible guide (5) from which the mobile hammer (13) is suspended. The flexible guide (5) includes at least two flexible blades, preferably two pairs (15, 25) of flexible blades (22, 23), the blades or pairs (15, 25) of blades (22, 23) being laterally arranged on either side of the hammer (13), the blades (22, 23) extending in the plane of movement of the hammer (13), such that the movement of the hammer (13) is translational, preferably substantially straight.

### CROSS REFERENCE TO RELATED APPLICATION

This application claims priority to European Patent Application No. 24216234.5 filed November 28, 2024, the entire contents of which are incorporated herein by reference.

### TECHNICAL FIELD OF THE INVENTION

The invention relates to the field of horology complications, and in particular to striking mechanisms in watches.

More specifically, the invention relates to a striking mechanism with a flexible guide.

Such a striking mechanism can be adapted to any type of striking work, such as quarter-hourly repeaters, minute repeaters, a grand strike, a small strike or an alarm.

### Technological background

Watch striking mechanisms commonly comprise a hammer for striking a vibrating element, such as a timbre.

In particular, the hammer is forced towards the vibrating element by a spring and is wound, meaning that it is kept away from the timbre, by an activation mechanism such as a lift or other dedicated mechanism.

The vibrating element generally extends in a curvilinear direction inside the watch case, for example around a central axis of said case. When the hammer strikes the vibrating element, it generates stresses on the vibrating element, causing it to vibrate and, as a result, produce the sound of the striking work. These stresses comprise a normal component and a tangential component, the latter characterising the friction of the hammer on the vibrating element.

In particular, the vibration of the vibrating element is essentially generated by the normal component of the stresses applied by the hammer, hence the need to control and maximise this normal component so as to control the effectiveness of the hammer's impact on the vibrating element and the sound produced by this impact.

New striking mechanisms have been designed that are fitted with flexible guides comprising at least one flexible blade from which the hammer is suspended. The hammer is mobile so that it can strike the vibrating element as a result of the distortion of the flexible guide, which also acts as a return spring.

Patent applications EP4310604 and EP4310605 describe examples of striking mechanisms fitted with flexible guides. In these documents, the hammer executes a rotational movement to strike the vibrating element.

However, when the hammer rotates, it does not strike the timbre from a direction that is exactly perpendicular to its surface. This results in a loss of sound intensity from the striking mechanism, as the energy transmitted to the timbre is not optimal.

### SUMMARY OF THE INVENTION

The invention remedies the aforementioned drawbacks by proposing, to this end, a striking mechanism for a horology movement, the striking mechanism comprising a vibrating element and a device for striking said vibrating element, the striking device comprising a mobile hammer for striking the vibrating element, and a flexible guide from which the hammer is suspended.

A remarkable feature of the invention is that the flexible guide comprises at least two flexible blades, preferably two pairs of flexible blades, with the blades or pairs of blades arranged laterally on either side of the hammer, the blades extending in the plane of movement of the hammer, such that the movement of the hammer is translational, preferably substantially straight.

This configuration enables the hammer to move in a direction perpendicular to the contact point with the vibrating element when it strikes it, thereby improving the impact of the hammer on the vibrating element.

In fact, the hammer moves in linear, preferably substantially straight, translation to strike the vibrating element.

Moreover, the hammer is kept securely in place by a flexible guide.

According to a particular embodiment of the invention, the flexible blades are arranged perpendicular to the direction of travel of the hammer when the striking device is in the locked position.

According to a particular embodiment of the invention, flexible blades in the same pair are substantially parallel.

According to a particular embodiment of the invention, the pairs of blades are arranged symmetrically relative to the direction of travel of the hammer.

According to a particular embodiment of the invention, the two pairs of blades are substantially collinear when the striking device is in its locked position.

According to a particular embodiment of the invention, the flexible guide comprises two supports, each pair being connected to a different support.

According to a particular embodiment of the invention, one of the supports comprises at least one oblong hole, for horizontally and laterally positioning the hammer relative to the timbre.

According to a particular embodiment of the invention, the striking mechanism comprises means for winding the striking device configured to move the hammer away from the vibrating element to give it momentum to strike the timbre

According to a particular embodiment of the invention, the winding means comprise a blom stud arranged on the hammer, and a rotationally mobile lift for moving the hammer. According to a particular embodiment of the invention, the hammer and the flexible guide are made in one piece

### BRIEF DESCRIPTION OF THE FIGURES

Other features and advantages of the invention will become apparent from the following detailed description, given by way of non-limiting example, with reference to the attached drawings in which:

- FIG. 1 shows a schematic top view of a striking mechanism comprising a striking device in a locked state, according to a preferred embodiment of the invention;

- FIG. 2 shows a schematic view from the underside of the striking mechanism in FIG. 1.

### DETAILED DESCRIPTION OF THE INVENTION

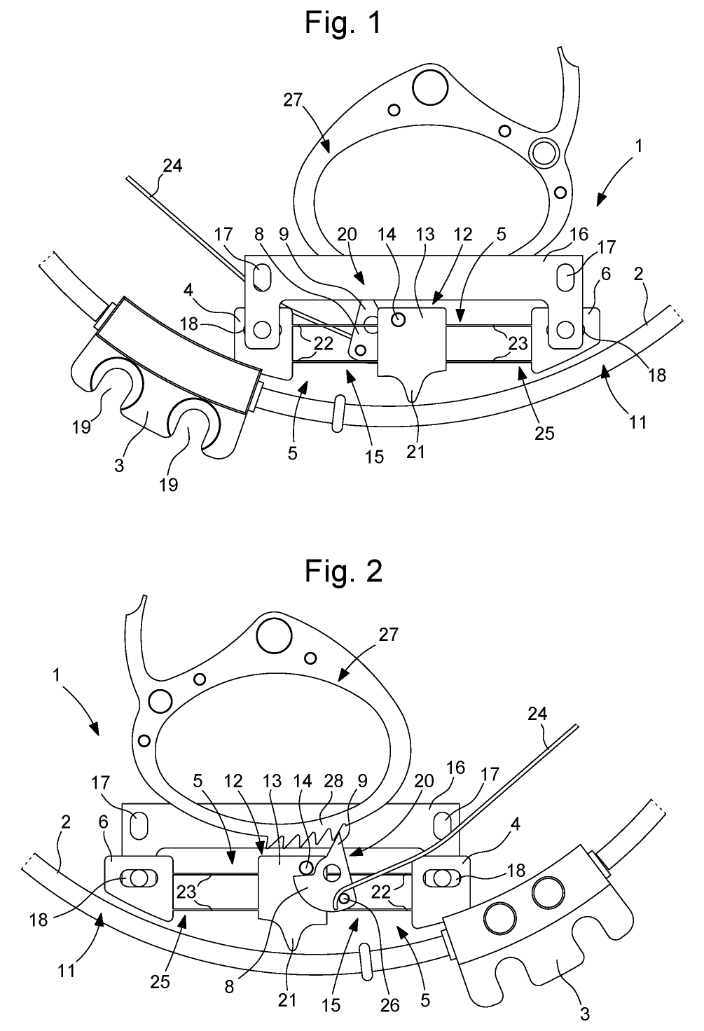

FIG. 1 shows a striking mechanism 1 for a horology movement in a watch in a preferred embodiment of the invention.

The striking mechanism 1 comprises a vibrating element 11 and a striking device 12 designed to strike said vibrating element 11 to produce a sound.

The vibrating element 11 is fastened to a structure on the horology movement, for example to a bar, a plate, etc., by a body 3 comprising, in this example, two holes 19 for screws or pins. The vibrating element 11 also comprises a timbre 2 for emitting a sound when struck and to which the body 3 is fastened. In this example, the vibrating element 11 has a curved shape so that it can be easily incorporated into a rounded watch case.

Moreover, the striking device 12 comprises a hammer 13 arranged in the curvature of the timbre 2. The hammer 13 is translationally mobile, preferably in a substantially straight line, so that it can strike the timbre 2. The hammer 13 moves along an axis that is substantially perpendicular to the contact point between the hammer 13 and the timbre 2 so as to vibrate the vibrating element 11 as effectively as possible.

In this embodiment, the hammer 13 is substantially square and comprises a protrusion 21 arranged to contact the timbre 2 when the hammer 13 is propelled against the vibrating element 11. The hammer 13 is also fitted with a pin 14 arranged on the body so that it can be moved.

The striking device 12 also comprises a flexible guide 5 from which the hammer 13 is suspended.

Preferably, the hammer 13 moves in a plane corresponding to the plane formed by the timbre 2.

Alternatively, the hammer moves in a plane different to the plane formed by the timbre 2.

The flexible guide 5 comprises several flexible blades 22, 23. The flexible blades 22, 23 can be elastically distorted and are used in the present invention to guide and drive the hammer 13.

According to the invention, the flexible guide 5 comprises two pairs 15, 25 of flexible blades arranged on either side of the hammer 13. Each pair 15, 25 comprises two blades 22, 23, preferably substantially parallel to each other.

Alternatively, in a variant not shown in the figures, the flexible guide comprises two flexible blades arranged on either side of the hammer. In this case, a single flexible blade is arranged on either side of the hammer instead of a pair of flexible blades as shown in the figures.

Preferably, each blade 22, 23 is substantially straight when the striking device 12 is in a locked state, that is to say in an equilibrium position.

Preferably, the flexible blades 22, 23 extend in the plane of movement of the hammer 13. The blades 22, 23 are arranged perpendicular to the direction of travel of the hammer 13.

The two pairs 15, 25 of flexible blades 22, 23 are arranged symmetrically relative to the mobile hammer 13.

Preferably, two flexible blades 22, 23 on each part 15, 25 are substantially collinear when the flexible guide 5 is in its locked position.

The flexible guide 5 comprises two supports 4, 6, each pair of blades 15, 25 connecting one of the supports 4, 6 to the hammer 13. The supports 4, 6 are arranged symmetrically relative to the direction of travel of the hammer 13.

One of the supports 4, 6 comprises at least one oblong hole 18 for accommodating a screw or a pin, thereby enabling the hammer 13 to be positioned relative to the timbre 2, in particular to set the direction of travel of the hammer 13.

Preferably, the two supports comprise at least one oblong hole 18, preferably two oblong holes, for vertically and laterally positioning the hammer 13.

The longitudinal axis of the oblong hole is substantially parallel to the blades 22, 23 on the flexible guide 5 when the flexible guide 5 is in its locked position.

The striking device 12 also comprises winding means 20 configured to move the hammer 13 away from the vibrating element 11 to give it momentum to strike the timbre 2 through the resilient action of the flexible blades 22, 23 on the flexible guide 5.

The winding means 20 comprise a rotationally mobile lift 8, the lift 8 engaging with the blom stud 14 on the hammer 13 to push it away from the vibrating element, so as to force the pairs of blades 15, 25 to progressively distort until they reach a wound state.

The lift 8 comprises a body in which the periphery is fitted with a tooth 9 and a notch 7, as well as a hole to enable it to rotate around an axis of rotation. The notch 7 is in contact with the blom stud 14 on the hammer 13.

The winding means 20 also comprise a rack 27 fitted with toothing 28 engaging with the tooth 9 on the lift 8 to enable the lift 8 to turn. The rack thus meshes with tooth 9 to turn the lift 8 around its axis of rotation.

When lift 8 turns around its axis, the notch 7 pushes the blom stud 14 to move the hammer 13 away from the vibrating element 11.

In doing so, the blom stud 14 slides along the notch 7 until it is released from the notch 7. The hammer 13 is thus released, such that the flexible guide 5 moves the hammer 13 back against the vibrating element 11 to produce a sound.

The winding means 20 are actuated when a predetermined time value of the current time has elapsed or on instruction from a user. The winding means thus release the hammer 13, which is then driven by the resilient return force of the blades 22, 23 to strike the vibrating element 11, the striking device 12 being then in a percussion state.

The winding means 20 comprise a return spring 24 for the lift 8, to return it to its initial position after the timbre 2 has been struck by the hammer 13. In particular to keep the notch 7 in contact with the blom stud 14 on the hammer 13 during the process.

Thus, the lift 8 can push the hammer 13 back again for another strike. In this example, the return spring 24 is a blade that bears on a pin 26 arranged on one face of the lift 8.

Preferably, when the hammer 13 is in the locked position, a safety distance is arranged between the hammer 13 and the vibrating element 11 to prevent any inadvertent shock.

Preferentially, the flexible guide 5 and the hammer 13 are made in one piece. Thus, the striking device 12 is particularly easy to manufacture and its production cost is minimised. Furthermore, the mechanism is not likely to be affected by a loss of power during percussion due to any mechanical slack that might have existed if the striking device 12 had been designed by assembling various workpieces.

In particular, the striking device 12 can be made of amorphous metal, for example by casting or hot forming, or made of nickel or nickel-phosphorus, for example using the LIGA method.

Alternatively, the striking device 12, and in particular the blades 22, 23, can be made of silicon, for example by dry engraving, and more specifically by Deep Reactive Ion Etching, a manufacturing method known to the person skilled in the art by its acronym, DRIE. As an alternative, the blades 22, 23 can be made of steel and formed by laser machining, in particular using a femtosecond laser, or by electrical discharge machining.

In particular, the hammer 13 can comprise one or more weights made of a metallic material, for example tungsten, gold or steel, to which the blades 22, 23 are fastened by driving in, gluing, screws or pins.

Naturally, the invention is not limited to the embodiments described with reference to the figures, and variants could be envisaged without departing from the scope of the invention. For example, supplementary blades can be added in addition to the pairs of flexible blades arranged on the sides of the hammer.

1. A striking mechanism for a horology movement, the striking mechanism comprising a vibrating element and a striking device on said vibrating element, the striking device comprising a mobile hammer for striking the vibrating element, and a flexible guide from which the mobile hammer is suspended,
wherein the flexible guide comprises at least two flexible blades, preferably two pairs of flexible blades, the blades or pairs of blades being laterally arranged on either side of the hammer, the blades extending in the plane of movement of the hammer, such that the movement of the hammer is translational, preferably substantially straight.

2. The striking mechanism according to claim 1, wherein the flexible blades are arranged perpendicular to the direction of travel of the hammer when the striking device is in its locked position.

3. The striking mechanism according to claim 1, wherein flexible blades in the same pair are substantially parallel.

4. The striking mechanism according to claim 1, wherein the pairs of blades are arranged symmetrically relative to the direction of travel of the hammer.

5. The striking mechanism according to claim 1, wherein the two pairs of blades are substantially collinear when the striking device is in its locked position.

6. The striking mechanism according to claim 1, wherein the flexible guide comprises two supports, each pair being connected to a different support.

7. The striking mechanism according to claim 1, wherein at least one of the supports comprises at least one oblong hole, arranged substantially parallel to the blades on the flexible guide in the locked position, for positioning the hammer relative to the timbre.

8. The striking mechanism according to claim 1, further comprising means for winding the striking device configured to move the hammer away from the vibrating element to give it momentum to strike the timbre.

9. The striking mechanism according to claim 8, wherein the winding means comprise a blom stud arranged on the hammer, and a rotationally mobile lift for moving the hammer.

10. The striking mechanism according to claim 1, wherein the hammer and the flexible guide are made in one piece.

11. A horology movement, comprising the striking mechanism according to claim 1.
